(19) United States
(12) Patent Application Publication
(10) Pub. No.: US 2008/0241641 A1
(43) Pub. Date: Oct. 2, 2008

(54) Membrane electrode assembly for fuel cell and process for manufacturing the same

(76) Inventors: Atsushi Kurita, Obu-shi (JP); Gang Xie, Anjo-shi (JP); Chiaki Yamada, Hekinan-shi (JP)

Correspondence Address: KENYON & KENYON LLP, 1500 K STREET N.W., SUITE 700, WASHINGTON, DC, 20005, US

(21) Appl. No.: 12/076,616

(22) Filed: Mar. 20, 2008

(30) Foreign Application Priority Data
Mar. 26, 2007 (JP) 2007-79598

(51) Int. Cl. H01M 4/86; B32B 37/14

(52) U.S. Cl. 429/40; 429/12; 156/276

(57) ABSTRACT

A membrane electrode assembly for fuel cell includes a membrane, a cathode electrode layer, a cathode gas diffusion layer, an anode electrode layer, and an anode gas diffusion layer. At least one of the cathode electrode layer and the anode electrode layer includes a catalytic layer, and a water-repellent layer. The catalytic layer contains first electrically-conductive fibers and a catalyst, and is disposed on a side of the membrane in the thickness-wise direction of the membrane electrode assembly. The water-repellent layer contains second electrically-conductive fibers and a water repellent, and is disposed more away from the membrane than the catalytic layer is disposed in the thickness-wise direction of the membrane electrode assembly. The first electrically-conductive fibers exhibit a first fibrous average length. The second electrically-conductive fibers exhibit a second fibrous average length. The first average fibrous length is longer than the second average fibrous length.

The present invention is based on Japanese Patent Application No. 2007-79,598, filed on Mar. 26, 2007, the entire contents of which are incorporated herein by reference.

### BACKGROUND OF THE INVENTION

1. Field of the Invention

The present invention relates to a membrane electrode assembly for fuel cell, and a process for manufacturing the same.

2. Description of the Related Art

A conventional membrane electrode assembly comprises a membrane, a cathode electrode layer, a cathode gas diffusion layer, an anode electrode layer, and an anode gas diffusion layer. The membrane exhibits ionic conductivity. The cathode electrode layer is disposed on one of the thickness-wise opposite surfaces of the membrane. The cathode gas diffusion layer is disposed on the thickness-wise outer side of the cathode electrode layer. The anode electrode layer is disposed on the other one of the thickness-wise opposite surfaces of the membrane. The anode gas diffusion layer is disposed on the thickness-wise outer side of the cathode electrode layer.

Japanese Unexamined Patent Publication (KOKAI) Gazette No. 2003-123,769 discloses a conventional electrode for fuel cell. The conventional electrode comprises an electrode layer, which functions as a catalytic layer and which contains a fibrous substrate, such as inorganic fibers, like alumina whisker and silica whisker, or carbon fibers. According to the publication, the conventional electrode can inhibit the generation of cracks in the electrode layer.

Japanese Unexamined Patent Publication (KOKAI) Gazette No. 2004-119,398 discloses a conventional catalytic composition for battery. The conventional catalytic composition comprises fibrous carbon, electrically-conductive powdery grains and a water-repellant resin that are contained in at least a part of gas diffusion layer to be brought into contact with catalytic layer.

Japanese Unexamined Patent Publication (KOKAI) Gazette No. 8-180,879 discloses the following conventional technology: forming a paste, which includes carbon with a catalyst loaded and water-soluble short fibers, such as polyvinyl alcohol short fibers; coating the resulting paste in a sheet form, thereby forming a sheet-shaped member; and thereafter immersing the resultant sheet-shaped member in warm water to elute out the water-soluble short fibers to turn the remains of the eluted-out short fibers into pores, thereby forming an electrode provided with pores. According to the publication, the pores can improve the gas permeability of the thus produced electrode. Moreover, the publication sets forth that it is possible to use multiple specific water-soluble short fibers whose diameters differ to each other.

Japanese Unexamined Patent Publication (KOKAI) Gazette No. 2004-235,134 discloses an electrode substrate, which is manufactured by forming a first porous electrode substrate and a second porous electrode substrate, and then by superimposing the first porous electrode substrate and the second porous electrode substrate by means of thermal pressing. For example, the first porous electrode substrate is made by bonding first carbon fibers, exhibiting fibrous lengths of from 0.2 to 9 millimeters and diameters of from 0.1 to 5 micrometers, to each other with carbon, which is made by carbonizing a resin. Likewise, the second porous electrode substrate is made by bonding second carbon fibers, exhibiting fibrous lengths of from 3 to 20 millimeters and diameters of from 6 to 20 micrometers, to each other with carbon, which is made by carbonizing a resin. According to the publication, the first porous electrode substrate and the second porous electrode substrate are free from any catalysts and ionically-conductive substances, respectively. Moreover, the publication does not at all deal with a technology on catalytic layer, but deals with a technology on gas diffusion layer.

Inside conventional fuels cells, the electric-power generation reaction generates water. Accordingly, flooding might occur so that the electric-power generation performance of conventional fuel cells might degrade. The term, “flooding,” means that the generated water closes the flow passages, in which reaction gases such as air flow, to reduce the flow-passage areas. During the electric-power generating operation of fuel cell, it has been required to discharge the resulting water satisfactorily. Although various improvements have been conducted consequently to improve the water dischargeability of conventional membrane electrode assemblies, a membrane electrode assembly exhibiting furthermore improved water dischargeability has been longed for.

### SUMMARY OF THE INVENTION

The present invention has been developed in view of the aforementioned circumstances. It is therefore an object of the present invention to provide a membrane electrode assembly, which exhibits furthermore upgraded water dischargeability so that it is advantageous for inhibiting flooding, and a process for manufacturing the same.

A membrane electrode assembly according to a first aspect of the present invention comprises:

a membrane exhibiting ionic conductivity;

a cathode electrode layer being disposed on one of thickness-wise opposite surfaces of the membrane;

a cathode gas diffusion layer being disposed on a thickness-wise outer side of the cathode electrode layer;

an anode electrode layer being disposed on the other one of thickness-wise opposite surfaces of the membrane; and

an anode gas diffusion layer being disposed on a thickness-wise outer side of the anode electrode layer;

at least one of the cathode electrode layer and the anode electrode layer comprises:
a catalytic layer containing first electrically-conductive fibers and a catalyst, and being disposed on a side of the membrane in a thickness-wise direction thereof;
a water-repellent layer containing second electrically-conductive fibers and a water repellent, and being disposed more away from the membrane than the catalytic layer is disposed in a thickness-wise direction thereof; and

the first electrically-conductive fibers, being contained in the catalytic layer, exhibits a first fibrous average length, the second electrically-conductive fibers, being contained in the water-repellent layer, exhibits a second fibrous average length, and the first average fibrous length is longer than the second average fibrous length.

In the membrane electrode assembly according to the first aspect of the present invention, at least one of the cathode electrode layer and the anode electrode layer comprises a membrane-side catalytic layer, and a water-repellent layer. Moreover, the water-repellent layer is disposed more away from the membrane than the catalytic layer is disposed in the thickness-wise direction of the membrane electrode assembly; in other words, the water-repellent layer is disposed on a more thickness-wise outer side than the membrane-side catalytic layer is disposed with respect to the membrane. The membrane-side catalytic layer is a layer that contains a catalyst actively, and thereby facilitates the electric-power generation reaction. On the contrary, the water-repellent layer contains a water repellant actively so that it facilitates the discharge of resultant water. However, the water-repellent layer is a layer that does not contain any catalyst actively at all.

Moreover, the first electrically-conductive fibers, which are contained in the catalytic layer being disposed nearer inwardly to the membrane in the thickness-wise direction, exhibit a first average fibrous length. On the other hand, the second electrically-conductive fibers, which are contained in the water-repellent layer being disposed more away outwardly from the membrane than the catalytic layer is disposed in the thickness-wise direction, exhibit a second average fibrous length. In addition, the first average fibrous length is longer than the second average fibrous length. Note herein that electrically-conductive fibers, which exhibit a longer average fibrous length, are more likely to increase voids or pores in catalytic layers than electrically-conductive fibers, which exhibit a shorter average fibrous length, do. Accordingly, the first conductive fibers make it possible to improve the dischargeability of the cathode electrode layer or anode electrode layer to water. Consequently, even when the electric-power generation reaction produces water so that the resulting water comes to exist at the interface between the membrane and the membrane-side catalytic layer of the cathode electrode layer or anode electrode layer, the membrane electrode assembly according to the first aspect of the present invention can demonstrate the dischargeability to the resultant water more satisfactorily.

In addition, in the membrane electrode assembly according to the first aspect of the present invention, the cathode electrode layer can preferably comprise the membrane-side catalytic layer, and the water-repellent layer. Moreover, even the anode electrode layer can comprise the membrane-side catalytic layer, and the water-repellent layer as well. The first electrically-conductive fibers, which are contained in the membrane-side catalytic layer, can preferably exhibit a first average fibrous length of from 7 to 100 micrometers, further preferably from 10 to 50 micrometers, furthermore preferably from 10 to 20 micrometers. On the other hand, the second electrically-conductive fibers, which are contained in the water-repellent layer, can preferably exhibit a second average fibrous length of from 2 to 50 micrometers, further preferably from 3 to 15 micrometers, furthermore preferably from 5 to 9 micrometers. In short, the cathode electrode layer or anode electrode layer can comprise a combination of the catalytic layer being disposed nearer inwardly to the membrane and the water-repellent layer being disposed more away outwardly from the membrane than the catalytic layer is disposed, combination in which a first average fibrous length of the first electrically-conductive fibers being contained in the membrane-side catalytic layer can be longer relatively than a second average fibrous length of the second electrically-conductive fibers being contained in the outside water-repellent layer. Thus, voids or pores, which are suitable for discharging water, are likely to generate in the membrane-side catalytic layer. Considering the corrosion resistance and electric conductivity of the first electrically-conductive fibers and second electrically-conductive fibers, the first electrically-conductive fibers and second electrically-conductive fibers can preferably comprise a carbon fiber.

A membrane electrode assembly according to a second aspect of the present invention for fuel cell is one of preferable modifications of the above-described first aspect, that is, at least one of the cathode electrode layer and the anode electrode layer can preferably be the cathode electrode layer. Specifically, the electric-power generation reaction generates more water in the cathode electrode layer than in the anode electrode layer. Therefore, the membrane electrode assembly according to the second aspect of the present invention comprises the cathode electrode layer, which demonstrates the satisfactory dischargeability to water more securely.

A membrane electrode assembly according to a third aspect of the present invention for fuel cell is another one of preferable modifications of the above-described first aspect, that is: both of the cathode electrode layer and the anode electrode layer comprise the catalytic layer, and the water-repellant layer, respectively;

the catalytic layer, which is disposed on a side of the cathode electrode layer, contains the first electrically-conductive fibers in a first content per unit area;

the catalytic layer, which is disposed on a side of the anode electrode layer, contains the first electrically-conductive fibers in a second content per unit area; and

the first content per unit area is larger than the second content per unit area.

As described above, the electric-power generation reaction generates more water in the cathode electrode layer than in the anode electrode layer. Therefore, the membrane electrode assembly according to the third aspect of the present invention comprises the cathode electrode layer, which demonstrates the satisfactory dischargeability to water much more securely.

A fourth aspect of the present invention is a process for manufacturing a membrane electrode assembly for fuel cell, and comprises the steps of:

preparing longer electrically-conductive fibers exhibiting a first average fibrous length, shorter electrically-conductive fibers exhibiting a second average fibrous length being relatively shorter than the first average fibrous length of the longer electrically-conductive fibers, a membrane exhibiting ionic conductivity, and a gas diffusion layer being faceable to the membrane;

laminating a water-repellent layer, containing the shorter electrically-conductive fibers and a water repellent, onto one of opposite surfaces of the gas diffusion layer facing the membrane, and then laminating an outer catalytic layer, containing the longer electrically-conductive fibers and a catalyst, onto the water-repellent layer, thereby forming an outer intermediate in which the outer catalytic layer is disposed on the water-repellent layer, and additionally

laminating an inner catalytic layer, containing the longer electrically-conductive fibers and a catalyst, onto one of opposite surfaces of the membrane facing the gas diffusion layer, thereby forming a membrane-side intermediate in which the inner catalytic layer is disposed on the membrane; and

laminating the outer intermediate onto the membrane-side intermediate so as to face the outer catalytic layer to the inner catalytic layer, thereby manufacturing a membrane electrode assembly.

In order to enhance the electric-power generation performance of fuel cell, it is possible to say that it is preferable to apply a catalytic layer, which contains a catalyst, in a thicker thickness. However, there surely are limitations on applying a catalytic layer thicker. In order to overcome the limitations, the manufacturing process according to the fourth aspect of the present invention employs a catalytic layer, which comprises the outer catalytic layer of the outer intermediate and the inner catalytic layer of the membrane-side intermediate and which is formed by laminating the outer catalytic layer onto the inner catalytic layer, or vice versa. Accordingly, the resulting catalytic layer can exhibit an adequate thickness securely. Further, in order to make a catalyst contribute to the electric-power generation reaction efficiently, it is preferable that a catalyst can be present as much as possible on one of the sides of membrane to which conducting ions approach. In view of this fact, the manufacturing process according to the fourth aspect of the present invention employs the inner catalytic layer, which is disposed nearer to the membrane and which contains a catalyst more densely. Consequently, the catalyst existing more densely in the inner catalytic layer can contribute to the electric-power generation reaction more effectively. Furthermore, even if the catalyst being contained in the inner catalytic layer should have been degraded because of being used for a long period of time, a catalyst being contained in the outer catalytic layer can contribute to the electric-power generation reaction instead. Therefore, the manufacturing process according to the fourth aspect of the present invention can manufacture a membrane electrode assembly that operates to produce the advantages, demonstrating much more upgraded dischargeability to water, for instance, in the same manner as the membrane electrode assembly according to the above-described first aspect does.

A fifth aspect of the present invention is another process for manufacturing a membrane electrode assembly for fuel cell, and comprises the steps of:

preparing longer electrically-conductive fibers exhibiting a first average fibrous length, shorter electrically-conductive fibers exhibiting a second fibrous average length being relatively shorter than the first average fibrous length of the longer electrically-conductive fibers, a membrane exhibiting ionic conductivity, and a gas diffusion layer being faceable to the membrane;

forming a water-repellent layer, containing the shorter electrically-conductive fibers and a water repellent, on an opposite surface of the gas diffusion layer facing the membrane;

forming a catalytic layer, containing the longer electrically-conductive fibers and a catalyst, on at least one of an opposite surface of the membrane facing the gas diffusion layer and an opposite surface of the water-repellent layer facing the membrane; and

laminating the membrane, the catalytic layer, the water-repellent layer and the gas diffusion layer in this order, thereby manufacturing a membrane electrode assembly.

Hence, it is apparent that the membrane electrode assembly, which is manufactured in accordance with the manufacturing process according to the fifth aspect of the present invention, can operate to produce the advantages, demonstrating much more upgraded dischargeability to water, for instance, in the same manner as the membrane electrode assembly according to the above-described first aspect does.

The membrane electrode assembly according to the present invention comprises the catalytic layer and water-repellent layer, which make the cathode electrode layer and/or the anode electrode layer. The catalytic layer contains the first electrically-conductive fibers exhibiting the first average fibrous length. The water-repellent layer contains the second electrically-conductive fibers exhibiting the second average fibrous length. The first average fibrous length is longer than the second average fibrous length. As a result, the first electrically-conductive fibers are more likely to increase voids or pores in the catalytic layer than the second electrically-conductive fibers increase voids or pores in the water-repellent layer. Accordingly, the catalytic layer enables the cathode electrode layer and/or the anode electrode layer to show satisfactorily improved dischargeability to water. Consequently, even if water, which the electric-power generation reaction produces, should have been present at around the interface between the membrane and the catalytic layer, the membrane electrode assembly according to the present invention can discharge the water satisfactorily. Therefore, the present membrane electrode assembly can inhibit the flooding problem from arising, and can thereby demonstrate improved electric-power generation performance.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a cross-sectional diagram of a membrane electrode assembly according to Embodiment Form No. 1 of the present invention.

FIG. 2 is a cross-sectional diagram of a membrane electrode assembly according to Embodiment Form No. 2 of the present invention, and illustrates the membrane electrode assembly in the middle of the manufacture.

FIG. 3 is a cross-sectional diagram of a membrane electrode assembly according to Embodiment Form No. 3 of the present invention, and illustrates the membrane electrode assembly in the middle of the manufacture.

FIG. 4 is a cross-sectional diagram of a membrane electrode assembly according to Embodiment Form No. 4 of the present invention, and illustrates the membrane electrode assembly in the middle of the manufacture.

FIG. 5 is a cross-sectional diagram of a membrane electrode assembly according to Embodiment Form No. 5 of the present invention, and illustrates the membrane electrode assembly in the middle of the manufacture.

FIG. 6 is a cross-sectional diagram for illustrating a single-cell fuel cell.

FIG. 7 is a graph for illustrating the results of a voltage drop test on fuel cells according to examples and comparative examples.

FIG. 8 is a graph for illustrating the results of another voltage drop test on fuel cells according to another examples and comparative examples.

FIG. 9 is a graph for illustrating the results of an electric resistance test on water-repellent layers according to examples and comparative examples.

FIG. 10 is a graph for illustrating the results of a gas permeability test on water-repellent layers according to examples and comparative examples.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### Embodiment Form No. 1

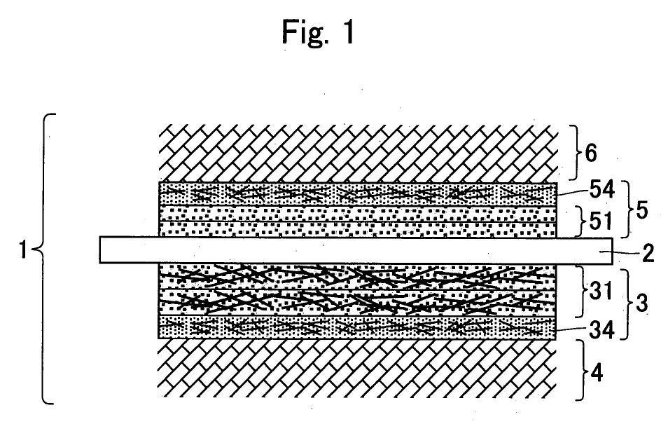

Embodiment Form No. 1 of the present invention will be hereinafter described with reference to FIG. 1. A membrane electrode assembly (hereinafter referred to as “MEA” wherever appropriate) according to Embodiment Form No. 1 for fuel cell is used in proton-exchange membrane fuel cells. As illustrated in FIG. 1, an MEA 1 comprises a membrane 2, a cathode electrode layer 3, a cathode gas diffusion layer 4, an anode electrode layer 5, and an anode gas diffusion layer 6. The membrane 2 is formed of a polymeric material, which exhibits ionic conductivity, for example, a perfluorosulfonic acid resinous material. The cathode electrode layer 3 is disposed on one of the thickness-wise opposite surfaces of the membrane 2, or on one of the thickness-wise opposite sides of the MEA 1. The cathode gas diffusion layer 4 is disposed on the thickness-wise outer side of the cathode electrode layer 3. The anode electrode layer 5 is disposed on the other one of the thickness-wise opposite surfaces of the membrane 2, or on the other one of the thickness-wise opposite sides of the MEA 1. The anode gas diffusion layer 6 is disposed on the thickness-wise outer side of the anode electrode layer 5. In the descriptions on Embodiment Form No. 1 and on the following embodiment forms of the present invention, the term, “ionic conductivity,” means protonic conductivity.

The cathode electrode layer 3 comprises a first catalytic layer 31, and a first water-repellent layer 34. The first catalytic layer 31 is disposed so as to face one of the thickness-wise opposite surfaces of the membrane 2, and has a thickness of from 40 to 60 micrometers, for instance. The first water-repellent layer 34 is disposed more away from the membrane 2 than the first catalytic layer 31 is disposed in the thickness-wise direction of the MEA 1, that is, the first water-repellent layer 34 is disposed on a more outer side than the first catalytic layer 31 is disposed with respect to the membrane 2. The first water-repellent layer 34 has a thickness of from 50 to 70 micrometers, for instance. The first catalytic layer 31 contains the following: longer carbon fibers as first electrically-conductive fibers; a catalyst; and a particulate auxiliary electrically-conductive substance; and an ionically-conductive substance; as the major components. For example, the catalyst comprises platinum; and the particulate auxiliary electrically-conductive substance comprises carbon black, such as acetylene black; and the ionically-conductive substance comprises a protonically-conductive substance, such as water. In the present specification, the phrase, “containing a constituent element as a major component,” means that a certain layer contains the constituent element in an amount of 5% by mass or more, or 10% by mass or more, when the layer is taken as 100% by mass. Note that the first catalytic layer 31 is prepared by compounding carbon with catalyst loaded with the longer carbon fibers and ionically-conductive substance. Moreover, the carbon with catalyst loaded is produced by loading the particulates of platinum (or a catalyst) on the surface of carbon black, such as acetylene black (or a particulate auxiliary electrically-conductive substance).

As illustrated in FIG. 1, the first water-repellent layer 34 faces the thickness-wise inner surface of the cathode gas diffusion layer 4, and contains shorter carbon fibers as second electrically-conductive fibers, a water repellent and a particulate auxiliary electrically-conductive substance. For example, the water repellent comprises a fluorocarbon polymer, and the auxiliary electrically-conductive substance comprises carbon black, such as acetylene black. Note that the first water-repellent layer 34 does not contain any catalyst actively at all because it is a layer that mainly aims at showing water repellency in order to facilitate the discharge of water from the MEA 1 and because it is disposed at such a position away from the membrane 2 in the thickness-wise direction of the MEA 1 that it is less likely to contribute to the electric-power generation reaction. Moreover, also note that such a phrase as “the first water-repellant layer 34 does not contain any catalyst actively at all” involves cases where the first water-repellent layer 34 might often contain a catalyst and/or the other substances passively when being made actually.

Moreover, the first electrically-conductive fibers, which are contained in the first catalytic layer 31, that is, the longer carbon fibers whose fibrous lengths are longer than those of the shorter carbon fibers relatively, exhibit an average fibrous length of from 10 to 50 micrometers, and an average fibrous diameter of from 0.05 to 0.3 micrometers. In addition, the second electrically-conductive fibers, which are contained in the first water-repellent layer 34, that is, the shorter carbon fibers whose fibrous lengths are shorter than those of the longer carbon fibers relatively, exhibit an average fibrous length of from 3 to 9 micrometers, and an average fibrous diameter of from 0.05 to 0.3 micrometers. Note that the longer carbon fibers (or first electrically-conductive fibers) can preferably exhibit a first average fibrous length that is longer than a second average fibrous length of the shorter carbon fibers (or second electrically-conductive substance) by a factor of from 1.2 to 4, more preferably from 1.4 to 3, much more preferably from 1.6 to 2.2.

As described above, the longer carbon fibers, which are contained in the first catalytic layer 31 being disposed nearer to the membrane 2 than the water-repellent layer 34 is disposed in the thickness-wise direction of the MEA 1, exhibit an average fibrous length that is longer than that of the shorter carbon fibers, which are contained in the water-repellent layer 34 being disposed more away from the membrane 2 than the first catalytic layer 31 is disposed in the thickness-wise direction of the MEA 1. Note herein that carbon fibers whose average fibrous length is longer tend to be more likely to increase voids or pores in the cathode electrode layer 3. Accordingly, the longer carbon fibers can improve the dischargeability of the cathode electrode layer 3 to water more. Consequently, even if the electric-power generation reaction produces water that comes to be present in the interface between the first catalytic layer 31 and the membrane 2, the MEA 1 can discharge the resulting water satisfactorily so that it inhibits the flooding and demonstrates upgraded electric-power generation performance.

Moreover, as illustrated in FIG. 1, the anode electrode layer 5 comprises a second catalytic layer 51, and a second water-repellent layer 54. The second catalytic layer 51 is disposed so as to face the other one of the thickness-wise opposite surfaces of the membrane 2, and has a thickness of from 20 to 40 micrometers, for instance. The second water-repellent layer 54 is disposed more away from the membrane 2 than the second catalytic layer 51 is disposed in the thickness-wise direction of the MEA 1, that is, the second water-repellent layer 54 is disposed on a more outer side than the second catalytic layer 51 is disposed with respect to the membrane 2. The second water-repellent layer 54 has a thickness of from 50 to 70 micrometers, for instance. Note however that, although the second catalytic layer 51 contains the following: a catalyst such as platinum; an ionically-conductive substance, such as a protonically-conductive substance; and a particulate auxiliary electrically-conductive substance, such as carbon black like acetylene black; as the major components, it does not contain any carbon fibers actively at all. The main reason is that, in the anode catalytic layer 5, the water dischargeability is worried less than in the cathode electrode layer 3. On the other hand, the second water-repellent layer 54 is a layer that mainly aims at showing water repellency in order to facilitate the discharge of water from the MEA 1. Therefore, although the second water-repellent layer 54 contains shorter carbon fibers, a water repellent, such as a fluorocarbon resin, and a particulate auxiliary electrically-conductive substance, such as carbon black, it does not contain any catalyst actively at all. However, depending on production processes or service forms, the second water-repellent layer 54 might contain a certain catalyst in a trace amount.

The second catalytic layer 51 is prepared by compounding carbon with catalyst loaded with the particulate auxiliary electrically-conductive substance. Moreover, the carbon with catalyst loaded is produced by loading the particulates of platinum (or a catalyst) on the surface of carbon black, such as acetylene black (or a particulate auxiliary electrically-conductive material). In addition, the shorter carbon fibers, which are contained in the second anode electrode layer 5's water-repellent layer 54, exhibit an average fibrous length of from 3 to 9 micrometers.

In the meantime, when generating electric power, a cathode gas, such as air, is supplied to the cathode electrode layer 3. On the other hand, an anode gas, such as a hydrogen gas, is supplied to the anode electrode layer 5. Thus, the electric-power generation reaction occurs, and thereby electric energy is taken out of the MEA 1. As the electric-power generation reaction develops, water is generated at the cathode electrode layer 3.

The MEA 1 according to Embodiment Form No. 1 of the present invention comprises the cathode electrode layer 3. Then, the cathode electrode layer 3 comprises the first catalytic layer 31, and the first water-repellent layer 34. The first catalytic layer 31 is disposed nearer to the membrane 2 than the first water-repellent layer 34 is disposed in the thickness-wise direction of the MEA 1, and contains the longer carbon fibers. The first water-repellent layer 34 is disposed more away from the membrane 2 than the first catalytic layer 31 is disposed in the thickness-wise direction of the MEA 1, and contains the shorter carbon fibers. Moreover, the longer carbon fibers exhibit an average fibrous length longer than that of the shorter carbon fibers do. As described above, carbon fibers whose average fibrous length is longer are more likely to increase voids or pores in the cathode electrode layer 3 than carbon fibers whose average fibrous length is shorter. As a result, the longer carbon fibers can improve the water dischargeability of the first catalytic layer 31 in the cathode electrode layer 3. Therefore, even if water is present at around the interface between the membrane 2 and the first catalytic layer 31, it is possible to discharge such water satisfactorily. All in all, the MEA 1 according to Embodiment Form No. 1 makes it possible to inhibit flooding from occurring, and enables fuel cells to demonstrate upgraded electric-power generation performance.

Moreover, as the electric-power generation reaction develops, water is more likely to generate on the side of the cathode electrode layer 3 than on the side of the anode electrode layer 5. In view of this fact, the MEA 1 according to Embodiment Form No. 1 of the present invention comprises the first catalytic layer 31 that makes the cathode electrode layer 3 and contains the longer carbon fibers actively, and the second catalytic layer 51 that makes the anode electrode layer 5 but does not contain any carbon fibers actively at all. In other words, the first catalytic layer 31 that makes the cathode electrode layer 3 contains the longer carbon fibers in a greater content by per unit area than the second catalytic layer 51 that makes the anode electrode layer 5 does. Hence, the MEA 1 according to Example No. 1 can demonstrate the good water dischargeability securely on the side of the cathode electrode layer 3 at which flooding is more likely to occur.

Moreover, the MEA 1 according to Embodiment Form No. 1 of the present invention can contribute to inhibiting cracking from occurring in the cathode electrode layer 3 more effectively, because it comprises the first catalytic layer 31 that contains the longer carbon fibers actively.

### Embodiment Form No. 2

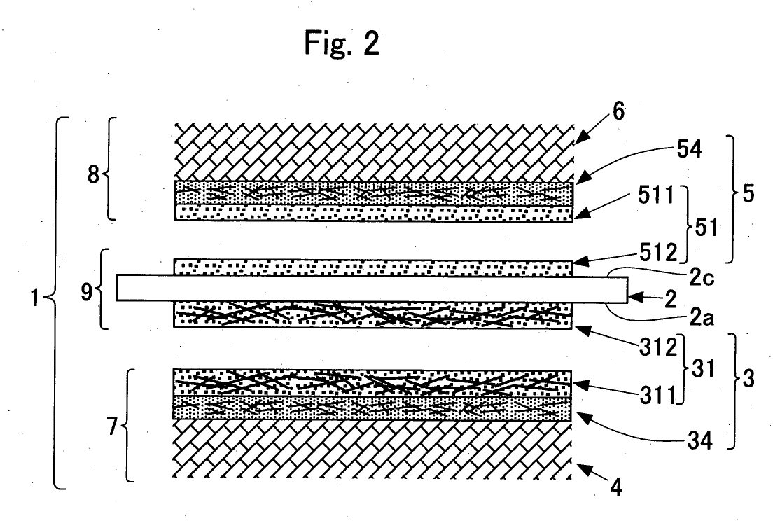

Embodiment Form No. 2 of the present invention will be hereinafter described with reference to FIG. 2. Basically, Embodiment Form No. 2 comprises the same constituent elements as those of Embodiment Form No. 1, and operates and effects advantages in the same manner as Embodiment No. 1. In accordance with Embodiment Form No. 2, first of all, the following are prepared: longer carbon fibers whose average fibrous length is longer relatively; and shorter carbon fibers whose average fibrous length is shorter relatively than that of the longer carbon fibers. Note herein that the longer carbon fibers exhibit an average fibrous length of from 10 to 50 micrometers, and an average fibrous diameter of from 0.05 to 0.3 micrometers, for instance. Moreover, the shorter carbon fibers exhibit an average fibrous length of from 3 to 9 micrometers, and an average fibrous diameter of from 0.05 to 0.3 micrometers, for instance.

Secondly, as illustrated in FIG. 2, a first water-repellent layer 34 is laminated onto one of the opposite surfaces of the cathode gas diffusion layer 4, opposite surface which faces the membrane 2. Note that that the first water-repellent layer 34 contains the above-described shorter carbon fibers, water repellent and particulate auxiliary electrically-conductive substance but does not contain any catalyst and ionically-conductive substance actively at all. Then, as illustrated in FIG. 2, a cathode-side first outer catalytic layer 311 is laminated onto the resulting first water-repellent layer 34. Note that the cathode-side first outer catalytic layer 311 contains the above-described longer carbon fibers, water repellent, particulate auxiliary electrically-conductive substance, ionically-conductive substance, and catalyst. Moreover, the particulate auxiliary electrically-conductive substance comprises carbon black; and the catalyst comprises platinum, for instance. As a result, a cathode-side first outer intermediate 7 is formed as shown in FIG. 2.

Thirdly, as illustrated in FIG. 2, a second water-repellent layer 54 is laminated onto one of the opposite surfaces of the anode gas diffusion layer 6, opposite surface which faces the membrane 2, in the same manner as the first water-repellent layer 34. Note that the second water-repellent layer 54 contains the above-described shorter carbon fibers, water repellent, particulate auxiliary electrically-conductive substance and ionically-conductive substance. Then, as illustrated in FIG. 2, an anode-side second outer catalytic layer 511 is laminated onto the resulting second water-repellent layer 54 in the same manner as the first outer catalytic layer 311. Note that the second outer catalytic layer 511 contains the above-described ionically-conductive substance, particulate auxiliary electrically-conductive substance and a catalyst, but does not contain any longer carbon fibers and water repellent actively at all. As a result, an anode-side second outer intermediate 8 is formed as shown in FIG. 2.

Fourthly, as illustrated in FIG. 2, a first inner catalytic layer 312 is laminated onto a surface (or cathode-side opposite surface) 2a of the opposite surfaces of the membrane 2 exhibiting ionic conductivity, surface 2a which faces the cathode gas diffusion layer 4, more specifically, the first outer catalytic layer 311 of the cathode-side first outer intermediate 7. Note that that the first inner catalytic layer 312 contains the above-described longer carbon fibers, ionically-conductive substance, particulate auxiliary electrically-conductive substance and catalyst. Moreover, the particulate auxiliary electrically-conductive substance comprises carbon black; and the catalyst comprises platinum, for instance. Likewise, as illustrated in FIG. 2, a second inner catalytic layer 512 is laminated onto a surface (or anode-side opposite surface) 2c of the opposite surfaces of the membrane 2 exhibiting ionically-conductivity, surface 2c which faces the anode gas diffusion layer 6, more specifically, the second outer catalytic layer 511 of the anode-side second outer intermediate 8. Note that that the second inner catalytic layer 512 contains the above-described ionic conductive substance, particulate auxiliary electrically-conductive substance, but does not contain any longer carbon fibers actively at all. Moreover, the particulate auxiliary electrically-conductive substance comprises carbon black; and the catalyst comprises platinum, for instance. Thus, a membrane-side intermediate 9 is formed as shown in FIG. 2.

Fifthly, the cathode-side first outer intermediate 7 and the anode-side second outer intermediate 8 are superimposed so as to held the membrane-side intermediate 9 therebetween, and are then joined together by pressing means, such as a hot-presser. Thus, the cathode-side first outer catalytic layer 311 and the cathode-side inner catalytic layer 312 are laminated with each other face-to-face. Similarly to the cathode-side first outer intermediate 7 and the anode-side second outer intermediate 8, the anode-side second outer intermediate 8 and the membrane-side intermediate 9 are joined together, and thereby the anode-side second outer catalytic layer 511 and the anode-side inner catalytic layer 512 are laminated with each other face-to-face. In accordance with the above-described procedure, an MEA 1 is manufactured.

In general, in order to enhance the electric-power generation performance of fuel cell, it is possible to say that it is preferable to apply the catalytic layers, which include the catalyst contributing to the electric-power generation reaction, in a thicker thickness in the cathode electrode layer 3 and anode electrode layer 5. However, applying the catalytic layer thicker is surely associated with limitations. In order to overcome the limitations, the manufacturing process according to Embodiment Form No. 2 of the present invention employs the first catalytic layer 31 in the cathode electrode layer 3. Specifically, the first catalytic layer 31 comprises the first outer catalytic layer 311 of the cathode-side first outer intermediate 7, and the first inner catalytic layer 312 of the membrane-side intermediate 9. Moreover, the first catalytic layer 31 is formed by laminating the first outer catalytic layer 311 and the first inner catalytic layer 312 with each other. Accordingly, the resulting first catalytic layer 31 can exhibit an adequate thickness securely in the cathode electrode layer 3, and is thereby advantageous for improving the electric-power generating performance of the MEA 1. Further, in order to make the catalyst contribute to the electric-power generation reaction efficiently, the catalyst can preferably be present as much as possible on the sides of membrane 2, which exhibits ionic conductivity. From this viewpoint, the manufacturing process according to Embodiment Form No. 2 of the present invention employs the first inner catalytic layer 312, which contains the catalyst more and which is disposed nearer to the membrane 2 in the cathode electrode layer 3. Consequently, it is possible for the first inner catalytic layer 312 to contribute to the electric-power generation reaction more effectively. Furthermore, even if the catalyst being contained in the first inner catalytic layer 312 of the cathode electrode layer 3 should have been degraded because of being used for a long period of time, it is possible to make the catalyst being contained in the first outer catalytic layer 311 of the cathode electrode layer 3 contribute to the electric-power generation reaction instead.

Moreover, the manufacturing process according to Embodiment Form No. 2 of the present invention employs the second catalytic layer 51 in the anode electrode layer 5. The second catalytic layer 51 likewise comprises the second outer catalytic layer 511 of the anode-side second outer intermediate 8, and the second inner catalytic layer 512 of the membrane-side intermediate 9. In addition, the second catalytic layer 51 is formed by laminating the second outer catalytic layer 511 and the second inner catalytic layer 512 with each other. Accordingly, the resulting second catalytic layer 51 can exhibit an adequate thickness securely in the anode electrode layer 5. Moreover, the second inner catalytic layer 512 is disposed nearer to the membrane 2 in the anode electrode layer 5. Consequently, it is possible for the second inner catalytic layer 512 to contribute to the electric-power generation reaction effectively. Further, even if the catalyst being contained in the second inner catalytic layer 512 of the anode electrode layer 5 should have been degraded because of being used for a long period of time, it is possible to make the catalyst being contained in the second outer catalytic layer 511 of the anode electrode layer 5 contribute to the electric-power generation reaction instead.

### Embodiment Form No. 3

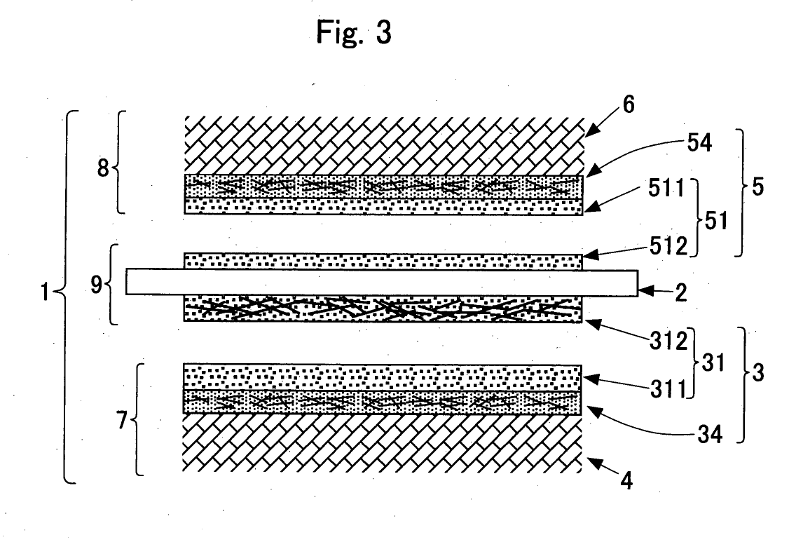

Embodiment Form No. 3 of the present invention will be hereinafter described with reference to FIG. 3. Basically, Embodiment Form No. 3 comprises the same constituent elements as those of Embodiment Form No. 2, and operates and effects advantages in the same manner as Embodiment Form No. 2. Embodiment Form No. 3 will be hereinafter described while focusing on the constituent elements of Embodiment Form No. 3 that differ from those of Embodiment Form No. 2. In Embodiment Mode No. 3 as well, the first catalytic layer 31 in the cathode electric layer 3 comprises the first inner catalytic layer 312, and the first outer catalytic layer 311. The first inner catalytic layer 312 is disposed nearer to the membrane 2 in the thickness-wise direction of the MEA 1. The first outer catalytic layer 311 is disposed more away from the membrane 2 than the first inner catalytic layer 312 is disposed in the thickness-wise direction of the MEA 1. Moreover, the first catalytic layer 31 is formed by laminating the first outer catalytic layer 311 and the first inner catalytic layer 312 with each other. In addition, as illustrated in FIG. 3, the first outer catalytic layer 311, which is disposed more away from the membrane 2 than the first inner catalytic layer 312 is disposed in the thickness-wise direction of the MEA 1, is free from the longer carbon fibers. On the other hand, the first inner catalytic layer 312, which is disposed nearer to the membrane 2 than the first outer catalytic layer 311 is disposed in the thickness-wise direction of the MEA 1, contains the longer carbon fibers.

Moreover, the cathode electrode layer 3 further comprises the first water-repellent layer 34 similarly. The first water-repellent layer 34 is disposed more away from the membrane 2 than the first inner catalytic layer 312 and first outer catalytic layer 311 are disposed in the thickness-wise direction of the MEA 1. In addition, the first water-repellent layer 34 contains the shorter carbon fibers. Moreover, the longer carbon fibers, which are contained in the first inner catalytic layer 312 being disposed nearest to the membrane 2 in the thickness-wise direction of the MEA 1, exhibit a longer average fibrous length than that of the shorter carbon fibers, which are contained in the first water-repellent layer 34 being disposed most away from the membrane 2 in the thickness-wise direction of the MEA 1. As a result, the cathode electrode layer 3 shows improved dischargeability to water at the first catalytic layer 312 in the first catalytic layer 31. Therefore, even if the electric-power generation reaction generates water that comes to exist at around the interface between the cathode electrode layer 3 and the membrane 2, the cathode electrode layer 3 enables the MEA 1 to discharge such water satisfactorily, and can thereby inhibit flooding from occurring. Thus, the MEA 1 according to Embodiment Form No. 3 of the present invention can make fuel cells, which demonstrate upgraded electric-power generating performance.

### Embodiment Mode No. 4

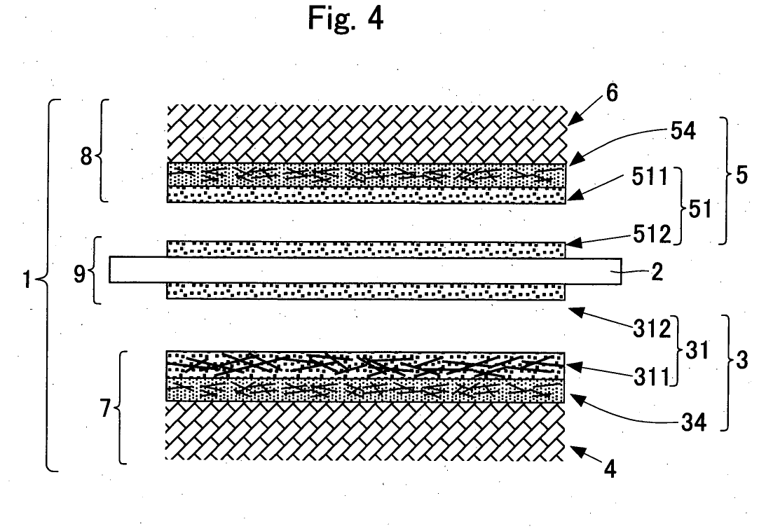

Embodiment Form No. 4 of the present invention will be hereinafter described with reference to FIG. 4. Basically, Embodiment Form No. 4 comprises the same constituent elements as those of Embodiment Form No. 2, and operates and effects advantages in the same manner as Embodiment Form No. 2. Embodiment Form No. 4 will be hereinafter described while focusing on the constituent elements of Embodiment Form No. 4 that differ from those of Embodiment Form No. 2. In Embodiment Mode No. 4 as well, the first catalytic layer 31 in the cathode electric layer 3 comprises the first inner catalytic layer 312, and the first outer catalytic layer 311. The first inner catalytic layer 312 is disposed nearer to the membrane 2 in the thickness-wise direction of the MEA 1. The first outer catalytic layer 311 is disposed more away from the membrane 2 than the first inner catalytic layer 312 is disposed in the thickness-wise direction of the MEA 1. Moreover, the first catalytic layer 31 is formed by laminating the first outer catalytic layer 311 and the first inner catalytic layer 312 with each other. Note herein that, as illustrated in FIG. 4, the first outer catalytic layer 311 contains the longer carbon fibers, though the first inner catalytic layer 312 does not contain any longer carbon fibers actively at all. In addition, the cathode electrode layer 3 further comprises the first water-repellent layer 34 similarly. Moreover, the first water-repellent layer 34 contains the shorter carbon fibers whose average fibrous length is shorter than that of the longer carbon fibers, which are contained in the first outer catalytic layer 311. Accordingly, even if water, which the electric-power generation reaction generates, is present at around the interface between the cathode electrode layer 3 and the membrane 2, the cathode electrode layer 3 shows satisfactory dischargeability to the resulting water, and can thereby inhibit the resultant water from flooding. Thus, the MEA 1 according to Embodiment Form No. 4 of the present invention makes it possible to manufacture fuel cells with upgraded electric-power generating performance.

### Embodiment Form No. 5

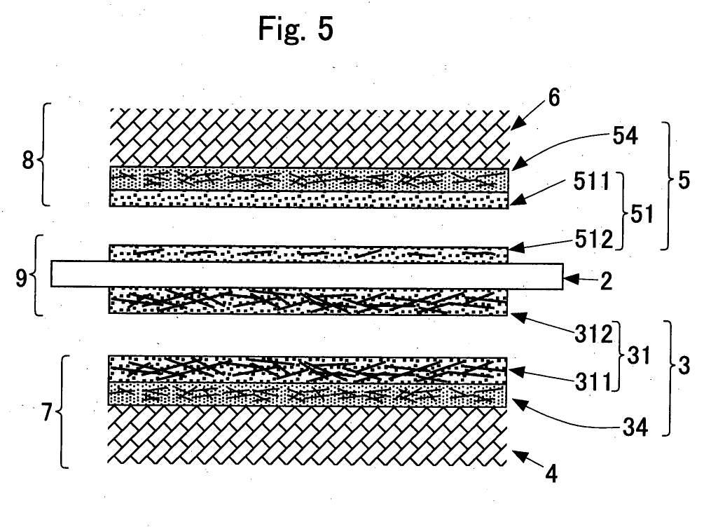

Embodiment Form No. 5 of the present invention will be hereinafter described with reference to FIG. 5. Basically, Embodiment Form No. 5 comprises the same constituent elements as those of Embodiment Form No. 2, and operates and effects advantages in the same manner as Embodiment Form No. 2. Embodiment Form No. 5 will be hereinafter described while focusing on the constituent elements of Embodiment Form No. 5 that differ from those of Embodiment Form No. 2. In Embodiment Mode No. 5, not only the first catalytic layer 31 in the cathode electric layer 3 comprises the first inner catalytic layer 312 containing the longer carbon fibers, but also the second catalytic layer 51 in the anode electric layer 5 comprises the second inner catalytic layer 512 containing the longer carbon fibers. Moreover, the anode catalytic layer 5 comprises the second water-repellent layer 54, which is disposed more away from the membrane 2 than the second inner catalytic layer 512 is disposed in the thickness-wise direction of the MEA 1. In addition, the second water-repellent layer 54 contains the shorter carbon fibers. Moreover, the second inner catalytic layer 512, which is disposed nearer to the membrane 2 than the second water-repellent layer 54 is disposed in the thickness-wise direction of the MEA 1, contains the longer fibers whose average fibrous length is longer than that of the shorter carbon fibers, which are contained in the second water-repellent layer 54 being disposed more away from the membrane 2 in the thickness-wise direction of the MEA 1. Accordingly, even if water, which the electric-power generation reaction generates, is present at around the interface between the anode electrode layer 5 and the membrane 2, the anode electrode layer 5 is very satisfactory in terms of the resulting water's dischargeability so that it is possible to inhibit the resultant water from flooding. Thus, the MEA 1 according to Embodiment Form No. 5 of the present invention enables fuel cells to demonstrate enhanced electric-power generating performance.

Note however that the cathode-side first catalytic layer 31 contains the longer carbon fibers in a greater content per unit area than the anode-side second catalytic layer 51 does. Such a preferable modification results from the fact that the electric-power generation reaction is more likely to generate water on the side of the cathode electrode layer 3 than on the side of the anode electrode layer 5.

### Example No. 1

An MEA according to Example No. 1 of the present invention was manufactured based on Embodiment Form No. 2 as described above and illustrated in FIG. 2.

(1) Formation of First Water-Repellent Layer 34 and Second Water-Repellent Layer 54

The following were prepared: 75-g acetylene black; 25-g fluorocarbon-resin dispersion; and 7.5-g shorter carbon fibers having relatively shorter fibrous lengths. The acetylene black was produced by DENKI KAGAKU Co., Ltd. The fluorocarbon-resin dispersion was “D-1” produced by DAIKIN KOGYO Co., Ltd., and included polytetrafluoroethylene (or PTFE) as a water repellent in a content of 60% by mass. The shorter carbon fibers were “VGCF-H” produced by SHOWA DENKO Co., Ltd., and had a fibrous length of from 5 to 9 micrometers and a fibrous diameter of 0.15 micrometers. The acetylene black, the fluorocarbon-resin dispersion, and the shorter carbon fibers were dispersed in water, and thereby a carbonaceous paste was formed. The resulting carbonaceous paste was applied in an application amount of 5 milligrams/cm² onto one of the thickness-wise opposite surfaces of a carbon paper by a doctor blade method. Note that the carbon paper made the cathode gas diffusion layer 4. Moreover, the carbon paper was “TGP-H-60” produced by TORAY Co., Ltd., and had a thickness of 200 micrometers. Then, the resultant cathode gas diffusion layer 4 was dried naturally, and was further calcined at about 380° C. for 1 hour. Thus, the cathode-side first water-repellent layer 34 was formed.

Similarly, the carbonaceous paste was applied in an application amount of 5 milligrams/cm² onto one of the thickness-wise opposite surfaces of another carbon paper by a doctor blade method. Note that the other carbon paper made the anode gas diffusion layer 6. Moreover, the other carbon paper was likewise “TGP-H-60” produced by TORAY Co., Ltd., and had a thickness of 200 micrometers. Then, the resulting cathode gas diffusion layer 6 was dried naturally, and was further calcined at about 380° C. for 1 hour. Thus, the anode-side second water-repellent layer 54 was formed.

Although the cathode-side first water-repellent layer 34 contained the shorter carbon fibers exhibiting electric conductivity and the acetylene black (i.e., an auxiliary electrically-conductive substance), it did not contain any ionically-conductive substance and catalyst actively at all.

Similarly to the cathode-side first water-repellent layer 34, although the anode-side second water-repellent layer 54 also contained the shorter carbon fibers exhibiting electric conductivity and the acetylene black (i.e., an auxiliary electrically-conductive substance), it did not contain any ionically-conductive substance and catalyst actively at all.

Note herein that, in the above-described carbonaceous paste, the addition amount of the shorter carbon fibers can preferably fall in a range of from 5 to 15 parts by mass with respect to the acetylene black taken as 100 parts by mass. According to the addition amount of the shorter carbon fibers, the summed amount of the shorter carbon fibers and acetylene black falls in a range of from 105 to 115 parts by mass when the entire acetylene black is expressed relatively as 100 parts by mass. Moreover, depending on conditions, the cathode-side first water-repellent layer 34 and anode-side second water-repellent layer 54 might exhibit electric conductivity and gas permeability insufficiently when the addition amount of the shorter carbon fibers is less than 5 parts by mass. In addition, depending on conditions, the cathode-side first water-repellent layer 34 and anode-side second water-repellent layer 54 might exhibit degraded film formability when the addition amount of the shorter carbon fibers exceeds 15 parts by mass. In general, the more the shorter fibers are compounded, the more increased electric conductivity and gas permeability the cathode-side first water-repellent layer 34 and anode-side second water-repellent layer 54 exhibit. However, the cathode-side first water-repellent layer 34 and anode-side second water-repellent layer 54 tend to exhibit constant gas permeability when the shorter carbon fibers are compounded in an amount of from 10 to 15 parts by mass with respect to the acetylene black taken as 100 parts by mass. For example, the cathode-side first water-repellent layer 34 and anode-side second water repellent layer 54 can preferably contain the shorter carbon fibers in an addition amount of from 5 to 15 parts by mass with respect to the acetylene black taken as 100 parts by mass.

(2) Formation of Cathode-Side First Outer Catalytic Layer 311

The following were prepared: 30-g carbon with platinum loaded; 300-g electrolytic resinous solution; and 1.5-g longer carbon fibers having relatively longer fibrous lengths. The carbon with platinum loaded comprised carbonaceous particles and platinum being loaded on the surface of the carbonaceous particles, and was “TEC10E50” produced by TANAKA KIKINZOKU Co., Ltd. The electrolytic resinous solution had a solid content of 5% by mass, and was “SS1100” produced by ASAHI KASEI Co., Ltd. The longer carbon fibers were “VGCF” produced by SHOWA DENKO Co., Ltd., and had a fibrous length of from 10 to 20 micrometers and a fibrous diameter of 0.15 micrometers. The carbon with platinum loaded, the electrolytic resinous solution, and the shorter fibers were dispersed in a mixture solution of water and isopropyl alcohol. Thus, a catalytic paste for forming cathode electrode layer (or a catalytic paste containing longer carbon fibers) was prepared. Note that the electrolytic resinous solution comprised an ionically-conductive substance (i.e., protons) exhibiting ionic conductivity (i.e., protonic conductivity). Then, the catalytic paste was applied onto the cathode-side first water-repellent layer 34, which was formed as set forth in (1) Formation of First Water-repellent Layer 34 and Second Water-repellent Layer 54, that is, as described specifically in above paragraph [0064], thereby a cathode-side first outer catalytic layer 311 was formed. As a result, the cathode-side first outer intermediate 7 was completed. As illustrated in FIG. 2, the cathode-side first outer intermediate 7 was formed by laminating the cathode-side first water-repellent layer 34 and the cathode-side first catalytic layer 311 in this order on the surface of the cathode gas diffusion layer 4.

As described above, the cathode-side first catalytic layer 311 comprised the longer carbon fibers exhibiting electric conductivity, the acetylene black (i.e., an auxiliary electrically-conductive substance), platinum (i.e., a catalyst), and water (i.e., an ionically-conductive substance, that is, protons).

(3) Formation of Anode-Side Second Outer Catalytic Layer 511

A catalytic paste for forming anode electrode layer was prepared. Note that the resulting catalytic paste had a composition, which could be approximated to that of the catalytic paste for forming cathode electrode as set forth in (2) Formation of Cathode-side First Outer Catalytic Layer 311, that is, as described specifically in above paragraph [0070]. However, the resultant catalytic paste was free from the longer carbon fibers. Then, the thus prepared catalytic paste for forming anode electrode layer (or a catalytic paste being free of any carbon fibers) was applied in an application amount of 2 milligrams/cm² by a doctor blade method onto the anode-side second water-repellent layer 54, which was formed as set forth in (1) Formation of First Water-repellent Layer 34 and Second Water-repellant Layer 54, that is, as described specifically in above paragraph [0064], and thereby an anode-side second outer catalytic layer 511 was formed. As a result, the anode-side second outer intermediate 8 was completed. As illustrated in FIG. 2, the anode-side second outer intermediate 8 was provided with the anode-side second water-repellant layer 54 and the anode-side second outer catalytic layer 511, which were laminated in this order on the surface of the anode gas diffusion layer 6. Note that the anode-side second outer catalytic layer 511 comprised platinum (or a catalyst) in a loading amount of 0.2 milligrams/cm². Although the anode-side second outer catalytic layer 511 comprised the acetylene black (i.e., an auxiliary electrically-conductive substance), platinum (i.e., a catalyst), and water (i.e., anionically-conductive substance, that is, protons), it did not contain the longer carbon fibers exhibiting electric conductivity actively at all.

(4) Formation of Cathode-Side First Inner Catalytic Layer 312

The same carbon with platinum loaded and longer carbon fibers that are set forth in (2) Formation of Cathode-side First Outer Catalytic Layer 311, that is, that were prepared as described specifically in above paragraph [0070], were prepared to make a catalytic paste for cathode electrode layer. The resulting catalytic paste was applied onto one of the thickness-wise opposite surfaces of the membrane 2, that is, the surface 2a thereof, by the Decal method (i.e., one of transfer methods), and thereby the cathode-side first inner catalytic layer 312 was laminated on the surface 2a of the membrane 2. Note that the cathode-side first inner catalytic layer 312 comprised platinum (or a catalyst) in a loading amount of 0.3 milligrams/cm². Moreover, the cathode-side first inner catalytic layer 312 can preferably comprise the longer carbon fibers in an addition amount of from 5 to 15 parts by mass with respect to the carbon with platinum loaded being taken as 100 parts by mass. In this instance, the summed amount of the longer carbon fibers and carbon with platinum loaded falls in a range of from 105 to 115 parts by mass when the entire carbon with platinum loaded is expressed relatively as 100 parts by mass. Note herein that there might be fears that the cathode-side first inner catalytic layer 312 exhibits insufficient electric conductivity and gas permeability when compounding the longer carbon fibers in an addition amount of less than 5 parts by mass. Moreover, there might be another fear that the cathode-side first inner catalytic layer 312 further exhibits insufficient flooding resistance when compounding the longer carbon fibers in an addition amount of less than 5 parts by mass. On the other hand, when the addition amount of the longer carbon fibers exceeds 15 parts by mass, there might be a fear that the completed MEA 1 demonstrates degraded electric-power generating performance because the thickness of the resultant cathode-side first inner catalytic layer 312 has become too thick.

(5) Formation of Anode-Side Second Inner Catalytic Layer 512

The same catalytic paste for anode electrode layer that is set forth in (3) Formation of Anode-side Second Outer Catalytic Layer 511, that is, that were prepared as described specifically in above paragraph [0073], was applied onto the other one of the thickness-wise opposite surfaces of the membrane 2, that is, the surface 2c thereof, by the Decal method (i.e., one of transfer methods), and thereby the anode-side second inner catalytic layer 512 was laminated on the surface 2c of the membrane 2. Note that the anode-side second inner catalytic layer 512 comprised platinum (or a catalyst) in a loading amount of 0.2 milligrams/cm². Thus, the membrane-side intermediate 9 was completed. The membrane-side intermediate 9 comprised the membrane 2, the cathode-side first inner catalytic layer 312, and the anode-side second inner catalytic layer 512. Note that, as shown in FIG. 2, the cathode-side first inner catalytic layer 312 is laminated on the bottom surface 2a of the membrane 2; and the anode-side second inner catalytic layer 512 was laminated on the top surface 2c of the membrane 2.

(6) Manufacture of MEA 1

The membrane-side intermediate 9 was placed between the first outer intermediate 7 and the second outer intermediate 8 so as to be held between them, and thereby a laminated preform was formed. The laminated perform was pressed with a hot-presser by applying a pressurizing force of 8 MPa to it in the thickness-wise direction. Thus, the MEA 1 was completed. Note herein that the first outer catalytic layer 311 and the second inner catalytic layer 312 were laminated on each other to make the cathode-side first catalytic layer 31. Moreover, the second outer catalytic layer 511 and the second inner catalytic layer 512 were laminated on each other to make the anode-side second catalytic layer 51.

As illustrated in FIG. 2, the resulting MEA 1 comprised the membrane 2, the cathode electrode layer 3, the cathode gas diffusion layer 4, the anode electrode layer 5, and the anode gas diffusion layer 2. The membrane 2 exhibited ionic conductivity. The cathode electrode layer 3 was disposed on one of the thickness-wise opposite surfaces of the membrane 2. The cathode gas diffusion layer 4 was disposed on the thickness-wise outer side of the cathode electrode layer 3. The anode electrode layer 5 was disposed on the other one of the thickness-wise opposite surfaces of the membrane 2. The anode gas diffusion layer 6 was disposed on the thickness-wise outer side of the anode electrode layer 5. Moreover, as shown in FIG. 2, the cathode electrode layer 3 comprised not only the first catalytic layer 31 but also the first water-repellent layer 34. The first catalytic layer 31 contained the acetylene black (i.e., an auxiliary electrically-conductive substance), the longer carbon fibers, the platinum (i.e., a catalyst), and water (or hydrogen ions, specifically, i.e., an ionically-conductive substance). The first water-repellent layer 34 contained the acetylene black (i.e., an auxiliary electrically-conductive substance), the shorter carbon fibers, and the fluorocarbon resin (or PTFE, specifically, i.e., a water repellent). Likewise, the anode electrode layer 5 comprised not only the second catalytic layer 51 but also the second water-repellent layer 54. The second catalytic layer 51 contained the acetylene black (i.e., an auxiliary electrically-conductive substance), the platinum (i.e., a catalyst), and water (or hydrogen ions, specifically, i.e., an ionically-conductive substance). The second water-repellent layer 54 contained the acetylene black (i.e., an auxiliary electrically-conductive substance), the shorter carbon fibers, and the fluorocarbon resin (or PTFE, specifically, i.e., a water repellent). Note herein that the anode-side second catalytic layer 51 did not contain any carbon fibers actively at all.

The MEA 1 according to Example No. 1 of the present invention comprised the cathode electrode layer 3, which was made of the first catalytic layer 31 and the first water-repellent layer 34. The first catalytic layer 31 was disposed nearer to the membrane 2 than the first water-repellent layer 34 was disposed in the thickness-wise direction of the cathode electrode layer 3, and accordingly the first water-repellent layer 34 was disposed more away from the membrane 2 than the first catalytic layer 31 was disposed in the thickness-wise direction of the cathode electrode layer 3. Moreover, the first catalytic layer 31, which was disposed nearer to the membrane 2, contained the longer carbon fibers, and the water-repellent layer 34, which was disposed more away from the membrane 2, contained the shorter carbon fibers. In addition, the longer carbon fibers exhibited an average fibrous length longer than the shorter carbon fibers did. Accordingly, the first catalytic layer 31 and first water-repellent layer 34 could satisfactorily improve the water dischargeability of the cathode electrode layer 3 to water. Consequently, even if the electric-power generation reaction should have generated water so that the resulting water should have existed at the interface between the membrane 2 and the first catalytic layer 31, the cathode electrode layer 3 could discharge such water with upgraded dischargeability. Therefore, the MEA 1 according to Example No. 1 enabled fuel cells, which were made therefrom, to demonstrate enhanced electric-power generating performance.

### Testing Example

### Electric-Power Generation Test

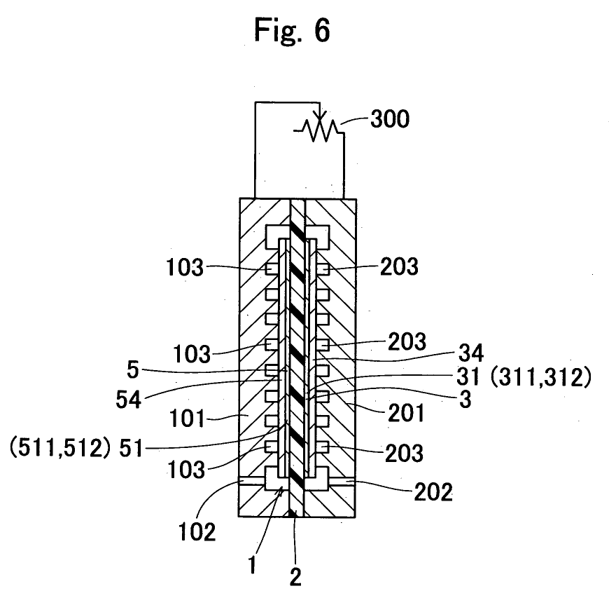

The MEA 1 being made as shown in FIG. 2 was used to manufacture a single-cell fuel cell. FIG. 6 illustrates the manufactured single-cell fuel. As shown in FIG. 6, the single-cell fuel cell comprised the MEA 1, a separator 101 for anode, and a separator 201 for cathode. The anode separator 101 was disposed on one of the thickness-wise opposite sides of the MEA 1, and was provided with a fuel-gas supply opening 102 and fuel-gas distributor grooves 103, which faced the anode electrode layer 5 of the MEA 1. The cathode separator 201 was disposed on the other one of the thickness-wise opposite sides of the MEA 1, and was provided with an oxidizing-agent-gas supply opening 202 and oxidizing-agent-gas distributor grooves 203, which faced the cathode electrode layer 3 of the MEA 1.

Moreover, the first inner catalytic layer 312 and first outer catalytic layer 311, which made the first catalytic layer 31 of the MEA 1's cathode electrode layer 3, were prepared variously so that they contained the longer carbon fibers in an addition amount of 0 parts by mass, 10 parts by mass, and 15 parts by mass, respectively, with respect to the carbon with platinum loaded being taken as 100 parts by mass. Note that the first inner catalytic layer 312 and first outer catalytic layer 311, which contained 0 parts-by-mass longer carbon fibers or which were free from the longer carbon fibers, are directed to Comparative Testing Example No. 1. On the other hand, the first inner catalytic layer 312 and first outer catalytic layer 311, which contained 10 parts-by-mass and 15 parts-by-mass longer carbon fibers, are directed to Testing Examples according to the present invention.

Then, to the single-cell fuel cell, air was supplied at 2.5 atm by gage pressure through the oxidizing-agent-gas supply opening 202 to the cathode electrode layer 3 by way of the oxidizing-agent-gas distributor grooves 203. At the same time, to the single-cell fuel cell, a hydrogen gas was supplied at 2.5 atm by gage pressure through the fuel-gas supply opening 102 to the anode electrode layer 5 by way of the fuel-gas distributor grooves 103. Thus, the single-cell fuel cell produced electric power. During the electric power generation, both of the air and hydrogen gas was humidified by a bubbling method. The produced electric power was taken out by way of the anode separator 101 and cathode separator 201, and the resulting electric current was flowed from the cathode separator 201 to the anode separator 101 via an external variable resistor 300 in order to examine the electric-power generation performance of the single-cell fuel cell by measuring the electric current density and cell voltage. During the electric-power generation performance test, the anode utilization factor was controlled at 90%, the cathode utilization factor was controlled at 40%, the electric-current density was controlled at 0.26 amperes/cm², and the cell temperature was controlled at 70° C. Further, the air (i.e., a cathode gas), which was supplied to the cathode electrode layer 3, was humidified variously to 58 RH %, 70 RH %, 80 RH % and 90 RH %, and the relative humidity was held thereat for 2 hours, respectively, in order to observe the degree of voltage drop resulting from flooding. Note that the designation, “RH %,” specifies relative humidity.

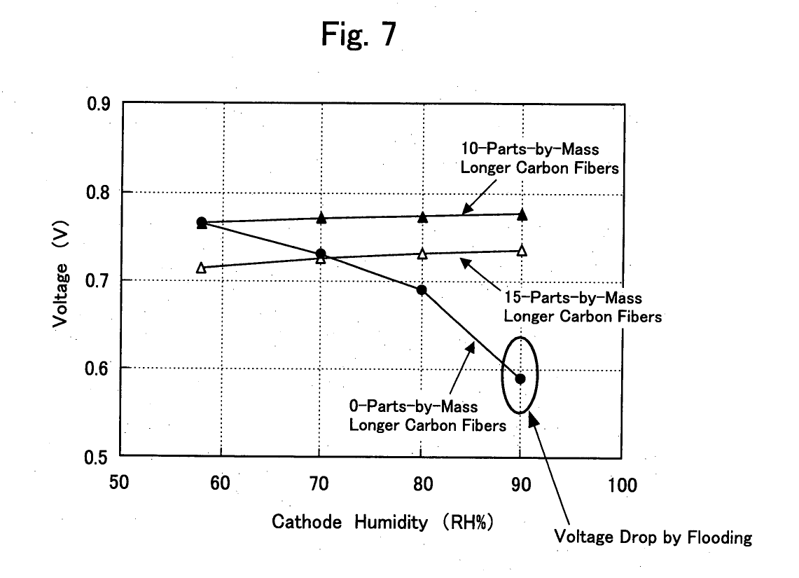

FIG. 7 illustrates the results of the electric-power generation performance test. In FIG. 7, note that the horizontal axis specifies the cathode-side humidity in RH %, that is, the relative humidity of air (i.e., a cathode gas) that was supplied to the cathode electrode layer 3. On the other hand, the vertical axis specifies the output voltage of single-cell fuel cell in volts. As can be seen from FIG. 7, when the cathode-side humidity was set at 70 RH % or less, the single-cell fuel cell according to Comparative Testing Example No. 1, which comprised the first catalytic layer 31 being free from any longer carbon fibers demonstrated favorable electric-power generation performance, because it produced a voltage as high as 0.7 volts or more that the single-cell fuel cell, which comprised the first catalytic layer 31 whose content of longer carbon fibers was set at 10 parts by mass with respect to the carbon with platinum loaded being taken as 100 parts by mass, and the single-cell fuel cell, which comprised the first catalytic layer 31 whose content of longer carbon fibers was set at 15 parts by mass with respect to the carbon with platinum loaded being taken as 100 parts by mass, did. However, when the cathode-side humidity became higher, specifically, 80 RH % or more, for instance, Comparative Testing Example No. 1 produced a sharply dropping voltage. The reason is inferred as follows. Since the relative humidity of air, which was supplied to the cathode electrode layer 3, became higher, flooding became likely to occur. As a result, the flooding occurred eventually, and accordingly adversely affected the voltage that Comparative Testing Example No. 1 produced. On the other hand, the single-cell fuel cells according to the present invention, which comprised the first catalytic layer 31 whose content of longer carbon fibers was set at 10 parts by mass and 15 parts by mass with respect to the carbon with platinum loaded being taken as 100 parts by mass, respectively, kept producing a high voltage even when they were operated under higher humidity condition where the cathode-side humidity was set higher, specifically, 80 RH % or more, for instance. The advantage is reasoned as follows. Since the cathode electrode layer 3 exhibited good dischargeability to water resulting from the electric-power generation reaction, it could inhibit the occurrence of flooding. Thus, the single-cell fuel cells according to the present invention demonstrated the good electric-power generation performance.

### Example Nos. 2 and 3

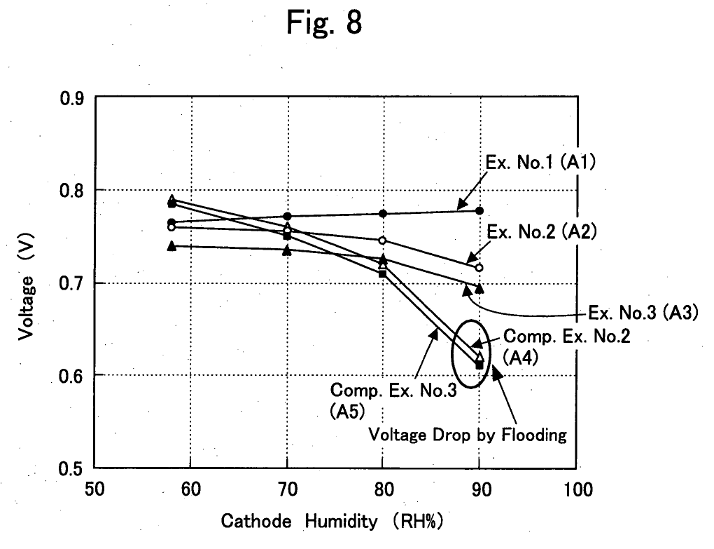

Moreover, FIG. 8 illustrates the results of the electric-power generation performance test on the single-cell fuel cells according to Example Nos. 2 and 3 and Comparative Example Nos. 2 and 3. In FIG. 8, the characteristic curve “A1” specifies the results of the electric-power generation performance test on the single-cell fuel cell according to Example No. 1. The characteristic curve “A2” specifies the results of the electric-power generation performance test on the single-cell fuel cell according to Example No. 2. The characteristic curve “A3” specifies the results of the electric-power generation performance test on the single-cell fuel cell according to Example No. 3. The characteristic curve “A4” specifies the results of the electric-power generation performance test on the single-cell fuel cell according to Comparative Example No. 2. The characteristic curve “A5” specifies the results of the electric-power generation performance test on the single-cell fuel cell according to Comparative Example No. 3. Although the single-cell fuel cell according to Example No. 2 was constructed in the same manner as the single-cell fuel cell according to Example No. 1 fundamentally, it differed from that in the following: the first inner catalytic layer 312 contained the longer carbon fibers; but the first outer catalytic layer 311 did not contain the longer carbon fibers. Likewise, although the single-cell fuel cell according to Example No. 3 was constructed in the same manner as the single-cell fuel cell according to Example No. 1 fundamentally, it differed from that in the following: the first inner catalytic layer 312 did not contain the longer carbon fibers; but the first outer catalytic layer 311 contained the longer carbon fibers. Moreover, although the single-cell fuel cell according to Comparative Example No. 2 was constructed in the same manner as the single-cell fuel cell according to Example No. 1 fundamentally, it differed from that in the following: both of the first inner catalytic layer 312 and first outer catalytic layer 311 did not contain the longer carbon fibers. In addition, although the single-cell fuel cell according to Comparative Example No. 3 was constructed in the same manner as the single-cell fuel cell according to Example No. 1 fundamentally, it differed from that in the following: both of the first inner catalytic layer 312 and first outer catalytic layer 311 did not contain the longer carbon fibers; and further both of the first water-repellent layer 34 and second water-repellent layer 54 did not contain the shorter carbon fibers.

As can be seen from FIG. 8, when the cathode-side humidity became higher, specifically, 80 RH % or more, for instance, the single-cell fuel cells according to Comparative Example Nos. 2 and 3 produced a sharply dropping voltage. It is inferred that the increasing relative humidity of air, which was supplied to the cathode electrode layer 3, made flooding likely to occur so that the voltage, which was produced by the single-cell fuel cells according to Comparative Example Nos. 2 and 3, was adversely affected by the resultant flooding. On the other hand, even when the cathode-side humidity became higher, specifically, 80 RH % or more, for instance, the single-cell fuel cells according to Example Nos. 1, 2 and 3 produced a voltage that hardly degraded. In particular, the single-cell fuel cell according to Example No. 1, which comprised the first outer catalytic layer 311 and first inner catalytic layer 312 both of which contained the longer carbon fibers, exhibited the advantage of inhibiting the voltage from dropping most remarkably. It is believed that it was inferably possible for the single-cell fuel cell according to Example No. 1 to inhibit flooding from occurring because the cathode electrode layer 3 exhibited good dischargeability to water resulting from the electric-power generation reaction.

(Electric Resistance Test)

Moreover, the water-repellent layer 34 of the MEA 1 according to Example No. 1 was examined for the electric resistance. Model test pieces having a predetermined size was made in the same manner as described above for making the first water-repellent layer 34 of the MEA 1 according to Example No. 1. Each of the test pieces had the following specific dimensions: a length of 30 millimeters; a width of 36 millimeters; that is, an area of 10.8 cm²; and a thickness of 0.5 millimeters. Note that the respective test pieces were made by the procedure as described above in Example No. 1. Specifically, first of all, the following were prepared: 75-g acetylene black; 25-g PTFE dispersion (i.e., a water repellent); and 7.5-g shorter carbon fibers having relatively shorter fibrous lengths. The acetylene black was produced by DENKI KAGAKU Co., Ltd. The PTFE dispersion was “D-1” produced by DAIKIN KOGYO Co., Ltd., and included PTFE (i.e., a solid component) in an amount of 60% by mass. The shorter carbon fibers were “VGCF-H” produced by SHOWA DENKO Co., Ltd., and had a fibrous length of from 5 to 9 micrometers and a fibrous diameter of 0.15 micrometers. Secondly, the acetylene black, the PTFE dispersion, and the shorter fibers were dispersed in water, and thereby a carbonaceous paste was formed. Thirdly, the resulting carbonaceous paste was applied in an application amount of 5 milligrams/cm² onto one of the thickness-wise opposite surfaces of a carbon paper by a doctor blade method. The carbon paper was “TGP-H-60” produced by TORAY Co., Ltd., and had a thickness of 200 micrometers. Fourthly, the resultant laminated member was dried naturally, and was further calcined at about 380° C. for 1 hour. Thus, a plurality of the model test pieces were completed. In the electric resistance test, the carbon paste contained the shorter carbon fibers in an addition amount that was changed variously as follows; 0 parts by mass, 5 parts by mass, 10 parts by mass, and 15 parts by mass with respect to the acetylene black taken as 100 parts by mass. For example, when the carbon paste contained the shorter carbon fibers in an addition amount of 10 parts by mass with respect to the acetylene black taken as 100 parts by mass, the summed amount of the shorter carbon fibers and acetylene was 110 parts by mass with respect to the entire acetylene black being expressed relatively as 100 parts by mass.

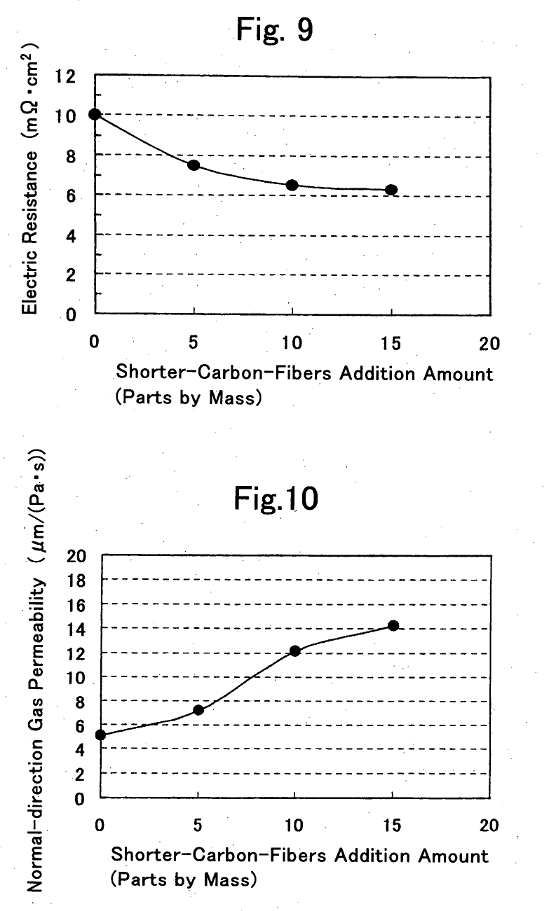

The resulting model test pieces were held between two carbon electrodes, respectively. Then, while applying 1.96-Mpa surface load to the model test pieces, a constant electric current was fed to the model test pieces to measure the output voltages that they produced. The resistances of the model test pieces were calculated from the resultant output voltage values. FIG. 9 illustrates the results of the electric resistance test. As shown in FIG. 9, it is understood that, as the addition amount of the short carbon fibers increased, the model test pieces exhibited a decreasing electric resistance and accordingly they exhibited augmenting electric conductivity. Therefore, in order to reduce the electric resistance of the first water-repellent layer 34, it is possible to say that the first water-repellent layer 34 can preferably contain the shorter carbon fibers, and that the first water-repellent layer 34 can more preferably contain the shorter carbon fibers in an amount of 5 parts by mass or more with respect to the acetylene black taken as 100 parts by mass. However, note that, as the addition amount of the short carbon fibers approaches 15 parts by mass with respect to acetylene black taken as 100 parts by mass, it is possible to say that the electric-resistance improvement effect, which results from the shorter carbon fibers, approaches the saturation. Therefore, the first water-repellent layer 34 can preferably contain the shorter carbon fibers in an addition amount of from 5 to 15 parts by mass with respect to the acetylene black taken as 100 parts by mass.

(Gas Permeability Test)

In addition, a gas permeability test was carried out in order to evaluate the gas permeability of the water-repellant layer 34 of the MEA 1 according to Example No. 1. In the gas permeability test, the model test pieces were fixed onto a plane surface, respectively. Then, a dried nitrogen gas was flowed through the fixed model test pieces perpendicularly to the opposite surfaces of the model test pieces. The pressure of the dried nitrogen gas before flowing into the model test pieces, and the pressure of the dried nitrogen gas after flowing out of the model test pieces were measured, thereby determining the pressure differences between the opposite surfaces of the model test pieces. FIG. 10 illustrates the results of the gas permeability test. It is seen from FIG. 10 that the increasing addition amount of the short carbon fibers resulted in the increment of the model test pieces' gas permeability. Therefore, for the purpose of enhancing the gas permeability of the first water-repellent layer 34, the following are notable: it is preferable to contain the shorter carbon fibers in the first water-repellent layer 34; and it is more preferable to contain the shorter carbon fibers in the first water-repellent layer 34 in an amount of 5 parts by mass or more with respect to the acetylene black taken as 100 parts by mass. However, the shorter carbon fibers' gas-permeability enhancement effect can be said to approach the saturation when the addition amount of the short carbon fibers is at around 15 parts by mass with respect to acetylene black taken as 100 parts by mass. Accordingly, it would be notable that it is much more preferable to contain the shorter carbon fibers in the first water-repellent layer 34 in an addition amount of from 5 parts by mass or more to 15 parts by mass or less with respect to the acetylene black taken as 100 parts by mass.

(Supplements)

The MEA 1 according to the above-described embodiment forms comprises the anode electrode layer 5 that is provided with the second catalytic layer 51 and the second water-repellent layer 54. However, it is allowable to employ such a form that the anode electrode layer 5 is provided with the second catalytic layer 51 but is free of the second water-repellent layer 54. Moreover, the specifications of the shorter carbon fibers and longer carbon fibers are not limited to the above-described specifications at all, and accordingly it is needless to say that it is feasible to modify the specifications properly, if necessary. In addition, the carbon black (i.e., an auxiliary electrically-conductive substance) is not limited to the carbon black, and accordingly it is allowable that the carbon black can be oil furnace black. Moreover, the present membrane electrode assembly and manufacturing process therefor are not limited to the embodiment forms and examples that are described above and are illustrated in the accompanying drawings, but it is feasible to modify the present membrane electrode assembly and manufacturing process therefor properly within ranges not departing from the spirit or scope of the present invention claimed below and then to practice them. In addition, it is feasible to apply the specific constructions and functions that make one of the embodiment forms and examples to the other embodiment forms and examples as well.

### INDUSTRIAL APPLICABILITY

The membrane electrode assembly and manufacturing process therefor according to the present invention can avail themselves of being fuel-cell systems for electronic instruments, electric instruments, vehicle instruments, portable instruments and electric-power generating instruments.

Having now fully described the present invention, it will be apparent to one of ordinary skill in the art that many changes and modifications can be made thereto without departing from the spirit or scope of the present invention as set forth herein including the appended claims.

What is claimed is:

1. A membrane electrode assembly comprising:
a membrane exhibiting ionic conductivity;
a cathode electrode layer being disposed on one of thickness-wise opposite surfaces of the membrane;
a cathode gas diffusion layer being disposed on a thickness-wise outer side of the cathode electrode layer;
an anode electrode layer being disposed on the other one of thickness-wise opposite surfaces of the membrane; and
an anode gas diffusion layer being disposed on a thickness-wise outer side of the anode electrode layer;
at least one of the cathode electrode layer and the anode electrode layer comprising:
a catalytic layer containing first electrically-conductive fibers and a catalyst, and being disposed on a side of the membrane in a thickness-wise direction thereof;
a water-repellent layer containing second electrically-conductive fibers and a water repellent, and being disposed more away from the membrane than the catalytic layer is disposed in a thickness-wise direction thereof; and
the first electrically-conductive fibers, being contained in the catalytic layer, exhibiting a first fibrous average length, the second electrically-conductive fibers, being contained in the water-repellent layer, exhibiting a second fibrous average length, and the first average fibrous length being longer than the second average fibrous length.

2. The membrane electrode assembly according to claim 1, wherein at least one of the cathode electrode layer and the anode electrode layer is the cathode electrode layer.

3. The membrane electrode assembly according to claim 1, wherein:
both of the cathode electrode layer and the anode electrode layer comprise the catalytic layer, and the water-repellant layer, respectively;
the catalytic layer, which is disposed on a side of the cathode electrode layer, contains the first electrically-conductive fibers in a first content per unit area;
the catalytic layer, which is disposed on a side of the anode electrode layer, contains the first electrically-conductive fibers in a second content per unit area; and
the first content per unit area is larger than the second content per unit area.

4. The membrane electrode assembly according to claim 1, wherein at least one of the first electrically-conductive fibers and the second electrically-conductive fibers comprises a carbon fiber.

5. The membrane electrode assembly according to claim 2, wherein the catalytic layer comprises:
a first catalytic layer being disposed nearer to the membrane in a thickness-wise direction thereof and being loaded with the catalyst more densely; and
a second catalytic layer being disposed more away from the membrane in a thickness-wise direction thereof and being loaded with the catalyst less densely.

6. The membrane electrode assembly according to claim 5, wherein both of the first catalytic layer and the second catalytic layer contain the first electrically-conductive fibers.

7. The membrane electrode assembly according to claim 5, wherein:
the first catalytic layer contains the first electrically-conductive fibers; and
the second catalytic layer is free from the first electrically-conductive fibers.

8. The membrane electrode assembly according to claim 5, wherein:
the first catalytic layer is free from the first electrically-conductive fibers; and
the second catalytic layer contains the first electrically-conductive fibers.

9. A process for manufacturing a membrane electrode assembly for fuel cell, the process comprising the steps of:
preparing longer electrically-conductive fibers exhibiting a first average fibrous length, shorter electrically-conductive fibers exhibiting a second average fibrous length being relatively shorter than the first average fibrous length of the longer electrically-conductive fibers, a membrane exhibiting ionic conductivity, and a gas diffusion layer being faceable to the membrane;
laminating a water-repellent layer, containing the shorter electrically-conductive fibers and a water repellent, onto one of opposite surfaces of the gas diffusion layer facing the membrane, and then laminating an outer catalytic layer, containing the longer electrically-conductive fibers and a catalyst, onto the water-repellent layer, thereby forming an outer intermediate in which the outer catalytic layer is disposed on the water-repellent layer, and additionally
laminating an inner catalytic layer, containing the longer electrically-conductive fibers and a catalyst, onto one of opposite surfaces of the membrane facing the gas diffusion layer, thereby forming a membrane-side intermediate in which the inner catalytic layer is disposed on the membrane; and
laminating the outer intermediate onto the membrane-side intermediate so as to face the outer catalytic layer to the inner catalytic layer, thereby manufacturing a membrane electrode assembly.

10. A process for manufacturing a membrane electrode assembly for fuel cell, the process comprising the steps of:
preparing longer electrically-conductive fibers exhibiting a first average fibrous length, shorter electrically-conductive fibers exhibiting a second fibrous average length being relatively shorter than the first average fibrous length of the longer electrically-conductive fibers, a membrane exhibiting ionic conductivity, and a gas diffusion layer being faceable to the membrane;
forming a water-repellent layer, containing the shorter electrically-conductive fibers and a water repellent, on an opposite surface of the gas diffusion layer facing the membrane;
forming a catalytic layer, containing the longer electrically-conductive fibers and a catalyst, on at least one of an opposite surface of the membrane facing the gas diffusion layer and an opposite surface of the water-repellent layer facing the membrane; and
laminating the membrane, the catalytic layer, the water-repellent layer and the gas diffusion layer in this order, thereby manufacturing a membrane electrode assembly.
